(19) United States
(12) Patent Application Publication
(10) Pub. No.: US 2024/0152585 A1
(43) Pub. Date: May 9, 2024

(54) USER ACCESS CONTROL METHOD FOR INFORMATION SYSTEM, USER ACCESS CONTROL APPARATUS FOR INFORMATION SYSTEM, AND STORAGE MEDIUM STORING INSTRUCTIONS TO PERFORM USER ACCESS CONTROL METHOD

(71) Applicant: AGENCY FOR DEFENSE DEVELOPMENT, Daejeon (KR)

(72) Inventors: Gyu Dong PARK, Daejeon (KR); Ho Cheol JEON, Daejeon (KR); Jong Oh KIM, Daejeon (KR); Hyoek Jin CHOI, Daejeon (KR)

(21) Appl. No.: 18/493,172

(22) Filed: Oct. 24, 2023

(30) Foreign Application Priority Data
Nov. 4, 2022 (KR) 10-2022-0146498

(51) Int. Cl. G06F 21/31; G06F 21/32

(52) U.S. Cl. CPC G06F 21/316; G06F 21/32

(57) ABSTRACT

A user access control method for an information system is proposed. The method may include processing login of a user using the information system, and acquiring a reference image obtained by capturing the logged-in user on the basis of a login time. The method may also include extracting reference feature information from the reference image and storing the reference feature information, and acquiring target images obtained by capturing a user using the information system at predetermined intervals. The method may further include extracting each target feature information from each target image; comparing each target feature information with the reference feature information to confirm whether or not each user using the information system at predetermined intervals is the same as the logged-in user, and controlling an access for the each user using the information system when the each user using the information system is not the same as the logged-in user.

### CROSS-REFERENCE TO RELATED APPLICATION

This application claims priority to Korean Patent Application No. 10-2022-0146498 filed on Nov. 4, 2022. The entire contents of the application on which the priority is based are incorporated herein by reference.

### TECHNICAL FIELD

The present disclosure relates to security technology, and more specifically, to a method and device for controlling access of a user who accesses an information system using an electronic device.

### BACKGROUND

With the development of networks, the accessibility of an information system such as a command and control system has been greatly improved so that the accessibility is independent of time and place, and the importance of security of the information system is also rapidly increasing. In a system that handles sensitive information or performs important missions, such as a command and control system, security should be provided to strictly restrict access by unauthorized users while ensuring access to resources by authorized users.

Thus, an IdAM (Identity and Access Management) technology can be used to manage entities or users accessing the information system.

### SUMMARY

One aspect is a method and device for preventing an information system device from being used by an unauthorized user.

Another aspect is a method and device for minimizing inconvenience of a user using an information system, and controlling access of the user to the information system without building additional equipment for identity information management.

Another aspect is a user access control method for an information system, that comprises: processing login of a user using the information system; acquiring a reference image obtained by capturing the logged-in user on the basis of a login time; extracting reference feature information from the reference image and storing the reference feature information; acquiring target images obtained by capturing a user using the information system at predetermined intervals; extracting each target feature information from each target image; comparing each target feature information with the reference feature information to confirm whether or not each user using the information system at predetermined intervals is the same as the logged-in user; and controlling an access for the each user using the information system when the each user using the information system is not the same as the logged-in user.

The extracting of the reference feature information may include extracting a region of interest (ROI) which is a region in which a face of the logged-in user is preset, from the reference image, and the extracting of each target feature information may include extracting a region of interest which is a region in which a face of the user using the information system is present, from each target image.

The extracting the reference feature information may include extracting a skin region boundary image indicating a boundary of the region in which skin of the logged-in user is present, and the extracting each target feature information may include extracting a skin region boundary image indicating a boundary of the region in which skin of the user using the information system is present.

The extracting the reference feature information may include extracting glasses detection information indicating whether or not glasses of the logged-in user are present, and the extracting each target feature information may include extracting glasses detection information indicating whether or not glasses of the user using the information system are present.

The extracting the reference feature information may include extracting mask wearing information indicating whether or not a mask of the logged-in user is present, and the extracting each target feature information may include extracting mask wearing information indicating whether or not a mask of the user using the information system is present.

The controlling the access for the each user using the information system may include switching to a state in which an input of an input device included in the information system is restricted or a state in which an output of an output device included in the information system is restricted.

The controlling the access for the each user using the information system may include maintaining an operation of the information system without restricting the operation of the information system when each user using the information system is the same as the logged-in user.

The controlling the access for the each user using the information system may include checking whether or not the user using the information system is the same as the logged-in user using a first target feature information corresponding to a first target image captured at a first time among predetermined intervals, and then, deleting the first target feature information corresponding to the first target image captured at the first time.

The controlling the access for the each user using the information system may include acquiring a second target image obtained by capturing the user using the information system when a time of the predetermined intervals has elapsed from the first time.

The controlling the access for each user using the information system may include controlling the access so that each user using the information system is restricted, when the region of interest which is the region in which the face of the user using the information system is present is not extracted from each target image.

Another aspect is an apparatus for an information system device, that comprises: a storage medium storing one or more instructions, and a processor executing the one or more instructions stored in the storage medium, wherein the instructions, when executed by the processor, cause the processor to extract: process login of users using an information system, acquire a reference image obtained by capturing the logged-in user on the basis of a login time, extract reference feature information from the reference image and store the reference feature information, acquire target images obtained by capturing a user using the information system at predetermined intervals, extract each target feature information from each target image, compare each the target feature information with the reference feature information to confirm whether or not each user using the information system at predetermined intervals is the same as the logged-in user, and control an access for the each user using the information system.

The processor is configured to extract a region of interest (ROI) which is a region in which a face of the logged-in user is preset, from the reference image, and extract a region of interest which is a region in which a face of the user using the information system is present, from the each target image.

The processor is configured to switch to a state in which an input of an input device included in the information system is restricted or a state in which an output of an output device included in the information system is restricted.

The processor is configured to check whether or not the user using the information system is the same as the logged-in user using a first target feature information corresponding to a first target image captured at a first time among predetermined intervals, and then, delete the first target feature information corresponding to the first target image captured at the first time.

The processor is configured to acquire the target image obtained by capturing the user using the information system at a second time when a time of the predetermined time intervals has elapsed from the first time.

The processor is configured to control the access so that each user using information system is restricted, when the region of interest which is the region in which the face of the user using the information system is present is not extracted from the each target image.

Another aspect is a non-transitory computer-readable recording medium storing a computer program, that comprises instructions for a processor to perform a user access control method, the method comprise: processing login of a user using the information system; acquiring a reference image obtained by capturing the logged-in user on the basis of a login time; extracting reference feature information from the reference image and storing the reference feature information; acquiring target images obtained by capturing a user using the information system at predetermined intervals; extracting each target feature information from each target image; comparing each target feature information with the reference feature information to confirm whether or not each user using the information system at predetermined intervals is the same as the logged-in user; and controlling an access for the each user using the information system when the each user using the information system is not the same as the logged-in user. According to an embodiment of the present disclosure, it is possible to prevent a user device of the information system from being used by an unauthorized user.

Further, according to an embodiment of the present disclosure, it is possible to minimize inconvenience of a user using the information system, and control access of the user to the information system without building additional equipment for identity information management.

Further, according to an embodiment of the present disclosure, it is possible to identify unauthorized users and quickly control user access by utilizing a camera included in an information system device.

Further, according to an embodiment of the present disclosure, it is possible to prevent identity information from being leaked or stolen by extracting a schematic feature that cannot be used for identity authentication of a specific individual, temporarily using the schematic feature inside the information system device, and then discarding the schematic feature in order to control access of a user to the information system.

### BRIEF DESCRIPTION OF THE DRAWINGS

FIG. 1 is a conceptual diagram illustrating various embodiments of an information system device equipped with a user access management method according to an embodiment of the present disclosure.

FIG. 2 is a block diagram illustrating an information system equipped with the user access management method according to the embodiment of the present disclosure.

FIG. 3 is a block diagram conceptually illustrating functions of a user access management program according to an embodiment of the present disclosure.

FIG. 4 is a block diagram illustrating a detailed configuration of a feature information extraction unit included in the user access management program according to the embodiment of the present disclosure.

FIG. 5 is an exemplary procedure diagram of the user access management method according to the embodiment of the present disclosure.

### DETAILED DESCRIPTION

IdAM includes, as main functions, identity management, authentication, authorization, and access control. Here, the authentication may be an operation of confirming trust in an entity or user, the authorization may be an operation of confirming resource access authority for the entity or user, and the access control may be an operation of permitting or refusing a resource access request from the entity or user according to the authority. These authentication, authorization, and access control operations all rely greatly on identity information in identity management. The identity information is a sum of pieces of data uniquely describing the entity or user, and when identity information of a specific entity or user is leaked or stolen, an entity or user with the leaked or stolen information may access an information system and damage information managed inside the information system.

In particular, within an information system such as a command and control system, it is necessary to manage and protect identity information very strictly.

Currently, many information systems utilize, until logout, user trust established through one-time authentication at the time of log-in, and with the IdAM, it is possible to view traffic between a user and the system, but it is not possible to identify an owner of the traffic or a user of the device, and thus, it is not easy to recognize a user change even when a user changes on the way. Thus, when another user steals or illegally uses the user device in a logged-in state to the information system, there is a problem that the information managed inside the information system may be damaged.

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding disclosure. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

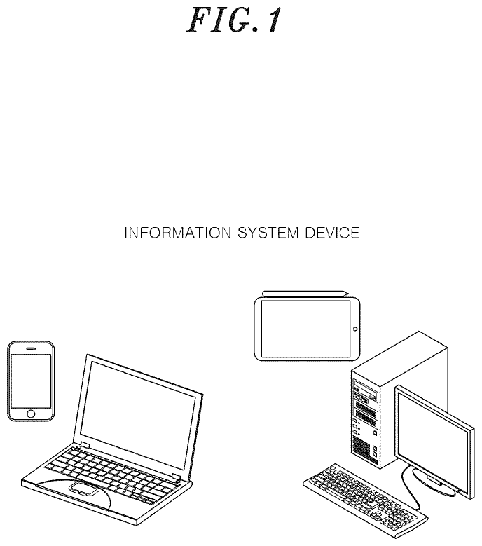

FIG. 1 is a conceptual diagram illustrating various embodiments of an information system device equipped with a user access management method according to an embodiment of the present disclosure.

Referring to FIG. 1, in an embodiment of the present disclosure, an information system device 100 may include various types of wired and wireless client devices, such as a cellular phone, a video phone, a smart phone, a notepad, laptop computer, a tablet computer, and a desktop computer.

In particular, the information system may be an information system built for a special purpose such as a military command and control system, and the information system device 100 is a special purpose user device equipped with an operating system (OS) for an information system such as a military command and control system.

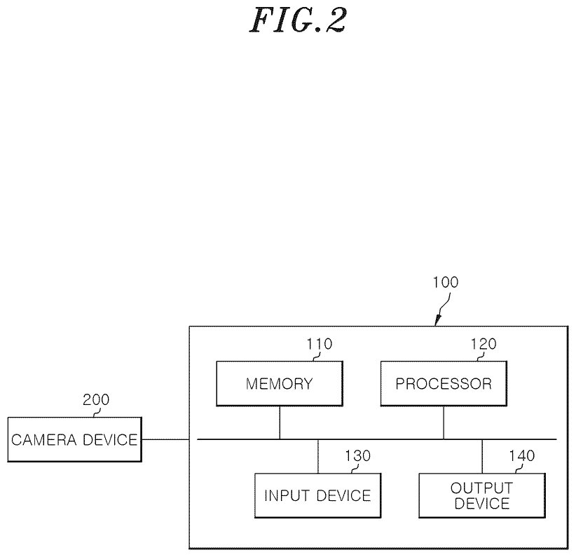

FIG. 2 is a block diagram illustrating the information system device equipped with a user access management method according to an embodiment of the present disclosure.

Referring to FIG. 2, the information system device 100 equipped with a user access management method according to an embodiment of the present disclosure may be connected to a camera device 200 and receive a video acquired from the camera device 200.

In particular, the information system device 100 may be configured to be able to perform the user access management method capable of controlling access of users who use the information system using the video acquired from the camera device 200. To this end, the information system device 100 may include a memory 110, a processor 120, an input device 130, and an output device 140.

The memory 110 may store the user access management program 300 and information required for execution of the user access management program 300. Further, the memory 110 may store various application programs that the information system device 100 can execute, and information required for execution of the various applications.

In the embodiment of the present disclosure, the user access management program 300 may refer to software including instructions programmed to control access of a user to the electronic device using the video acquired from the camera device 200.

The processor 120 can generally control an operation of the information system device 100.

The processor 120 may load the user access management program 300 and the information required for execution of the user access management program 300 from the memory 110 in order to execute the user access management program 300.

The processor 330 may execute the user access management program 300 to acquire a video through the camera device 200 at predetermined intervals, and may confirm the feature information of the user using the information system device 100 using the acquired video, confirm whether the user confirmed through the confirmed feature information matches a preset reference, and control the user access on the basis of a result of the confirmation. In particular, the processor 330 may control the operation of the input device 130 or the output device 140 or control the execution of various application programs that the information system device 100 can perform, on the basis of the confirmation result.

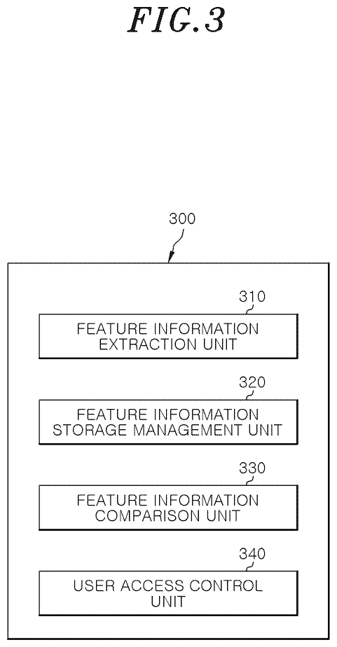

A detailed operation in which the processor 120 executes the user access management program 300 to control the operation of the electronic device will be described in detail with reference to FIG. 3 to be described below.

The input device 130 may be a device that processes a user input for controlling the information system device 100, and the output device 140 may be a device that displays information generated by an electronic device 100. The input device 130 and the output device 140 may be included in various ways depending on a type of electronic device 100. For example, the input device 130 and the output device 140 may be included as a device such as buttons, a touch pad, a mouse, or a keyboard, or may be included as a touch screen type device. Further, the output device 140 may be implemented as various types of displays, such as a liquid crystal display (LCD), an organic light emitting diode (OLED) display, or a plasma display panel (PDP). As another example, the output device 140 may be implemented as a touch screen combined with a touch sensor, a flexible display, a 3D display, or the like.

The information system device 100 may further include a communication unit 150. For example, the communication unit 150 may include a module for connection to a communication network using at least one of a cellular mobile communication scheme such as CDMA, GSM, W-CDMA, TD-SCDMA, WiBro, LTE, or 5G and a short-range wireless communication scheme such as Wi-Fi, Bluetooth, Zigbee, Wi-Fi Direct (WFD), Ultra wideband (UWB), infrared communication (IrDA; Infrared Data Association), Bluetooth Low Energy (BLE), and NFC (Near Field Communication).

FIG. 3 is a block diagram conceptually illustrating functions of a user access management program according to an embodiment of the present disclosure.

Referring to FIGS. 2 and 3, the user access management program 300 may include a feature information extraction unit 310, a feature information storage management unit 320, a feature information comparison unit 330, and a user access control unit 340.

The feature information extraction unit 310 may extract feature information from the video acquired from the camera device 200.

The user access management program 300 may be a program for periodically confirming whether or not there is a change in the user using the information system device 100, that is, whether or not the information system device 100 is being operated by the same user as a user logged in to the electronic device 100. Therefore, it is sufficient for the feature information to include information from which a confirmation can be made as to whether the user using the information system device 100 is the same as the logged-in user. Considering the above, the feature information extraction unit 310 may extract feature information including a boundary image of a face region of the user, whether or not glasses are detected, whether or not a mask is detected, and the like.

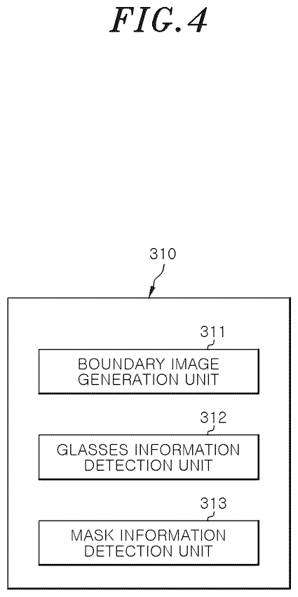

To this end, the feature information extraction unit 310 may extract a region in which there is a face of the user, that is, a face region ROI from the video acquired from the camera device 200. The feature information extraction unit 310 may extract feature information including the boundary image of the face region of the user, whether or not glasses are detected, whether or not a mask is detected, or the like using the face region ROI. A detailed operation of extracting such feature information will be described in detail with reference to FIG. 4 below.

Further, since the user access management program 300 is a program for periodically confirming whether or not the information system device 100 is being operated by the same user as the user logged in to the electronic device 100 as described above, it is necessary to separate and manage feature information of the logged-in user and feature information of users that are periodically confirmed. In consideration of this, the feature information extraction unit 310 may confirm an event in which the user log-in of the information system device 100 occurs, request the camera device 200 to capture a video, and manage the video acquired from the camera device 200 as a reference image.

The user access management program 300 may periodically generate the user access confirmation event at predetermined time intervals (for example, one minute) from a point in time when the user logs in. To this end, a menu or user interface for setting a time unit for performing a user access confirmation may be provided, and the time unit for performing a user access confirmation may be set on the basis of a user input that is input through such a menu or user interface.

As the user access confirmation event occurs, the feature information extraction unit 310 may request the camera device 200 to capture a video, and manage the video acquired from the camera device 200 in this case as a target image.

Further, the feature information extraction unit 310 may provide the feature information extracted from the reference image as reference feature information to the feature information storage management unit 320.

The feature information storage management unit 320 may manage the reference feature information provided by the feature information extraction unit 310 so that the reference feature information is stored in the memory 110. For example, the feature information storage management unit 320 may store the reference feature information in the memory 110 and manage address information in which the reference feature information is stored. The feature information storage management unit 320 may provide the address information in which the reference feature information is stored, to the feature information comparison unit 330.

Further, the feature information extraction unit 310 may provide the feature information extracted from the target image, as the target feature information, to the feature information storage management unit 320, and the feature information storage management unit 320 may manage the target feature information provided by the feature information extraction unit 310 so that the target feature information is stored in the memory 110.

Meanwhile, when the user access confirmation event occurs, the feature information comparison unit 330 may confirm the address information in which the reference feature information is stored, and confirm the reference feature information stored in the memory 110. Further, the feature information comparison unit 330 may confirm the target feature information provided by the feature information extractor 310, compare the target feature information with the reference feature information, and provide a result of the comparison.

The user access control unit 340 may control user access on the basis of a result of comparing the target feature information with the reference feature information. For example, the user access control unit 340 may block the output of the output device 140 when the target feature information is not the same as the reference feature information. For example, the user access control unit 340 may turn off the display included as the output device 140. Further, the user access control unit 340 may block an input from a mouse or keyboard included as the input device 130.

Additionally, when the information system device 100 is a laptop computer, tablet computer, desktop computer, or the like, the user may not use the information system device 100 and may be absent. In this case, since the feature information extraction unit 310 cannot extract the facial region ROI from the video acquired from the camera device 200, the feature information extraction unit 310 cannot extract the target feature information. Ultimately, a problem may occur in which the feature information comparison unit 330 cannot compare the reference feature information with the target feature information. Therefore, when the facial region ROI is not extracted, the feature information extraction unit 310 can transmit an error message to the user access control unit 340, and the user access control unit 340 can block user access.

FIG. 4 is a block diagram illustrating a detailed configuration of the feature information extraction unit included in the user access management program according to the embodiment of the present disclosure.

Referring to FIG. 4, the feature information extraction unit 310 may include at least one of a boundary image generation unit 311, a glasses information detection unit 312, and a mask information detection unit 313.

The boundary image generation unit 311 is a component that generates a boundary image of a face region of the user, and may receive the above-described face region ROI and construct an image indicating a boundary of the face of the user from the face region ROI. For example, the boundary image generation unit 311 extracts HSV of hue, saturation, and value from the image of the face region ROI, and use the extracted HSV to construct an image indicating the boundary of the face. Accordingly, the glasses information detection unit 312 can output the image indicating the boundary of the face.

The image indicating the boundary of the face has been constructed using the HSV in the embodiment of the present disclosure, but the present disclosure is not limited thereto and the boundary image generation unit 311 may construct the image indicating the boundary of the face using various schemes for detecting a boundary of a target. For example, the boundary image generation unit 311 may extract a YCbCr value from an image of the facial region ROI and construct the image indicating the boundary of the face using the extracted YCbCr value.

The glasses information detection unit 312 is a component that confirms whether or not the user is wearing glasses, and may receive the face region ROI and detect whether the user is wearing glasses from the face region ROI. For example, the glasses information detection unit 312 may extract landmarks such as eyes, nose, and mouth of the user from the face region ROI, analyze a region in which the nose and eyes are present, and confirm whether or not glasses are present in the image. Accordingly, the glasses information detection unit 312 can output information indicating whether or not the user is wearing glasses.

The mask information detection unit 313 is a component that confirms whether or not the user is wearing a mask, and may receive the face region ROI and detect whether the user is wearing a mask from the face region ROI. For example, the mask information detection unit 313 may extract landmarks such as eyes, nose, and mouth of the user from the face region ROI, analyze the region in which the nose and mouth are present, and confirm whether a mask is present in the image. Accordingly, the mask information detection unit 313 can output information indicating whether or not the user is wearing the mask.

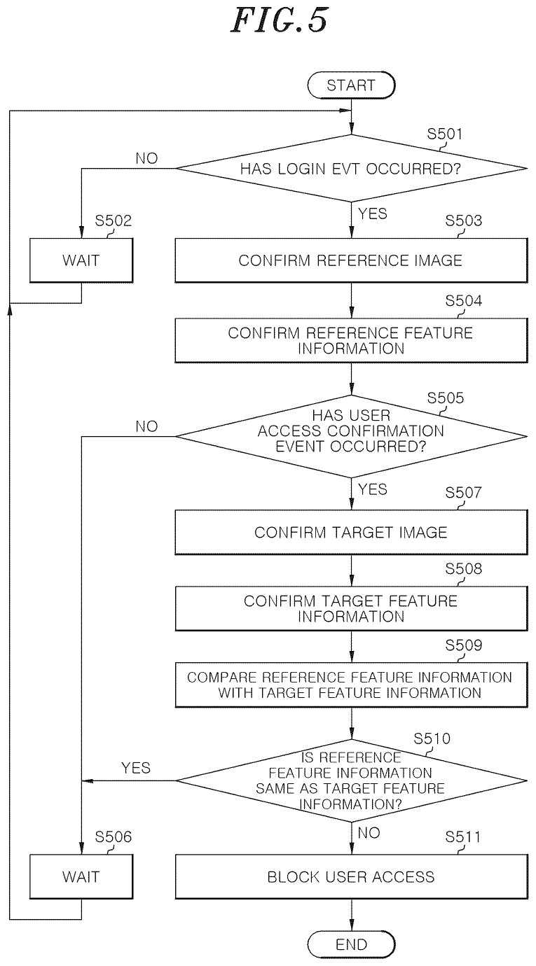

FIG. 5 is an exemplary procedure diagram of a user access management method according to an embodiment of the present disclosure.

First, the user access management method illustrated in FIG. 5 is an example in which the information system device equipped with the user access management program described above performs the user access management method.

In step S501, the information system device can confirm whether or not a login event has occurred. For example, the login event may occur when the user performs user authentication to use the information system device. For example, when the information system device is a smartphone, notepad, tablet computer, or the like, a screen lock function may be set, and the screen lock may be released by inputting a password, pattern, biometric information, or the like set by the user. When the screen lock is released in this way, the information system device may cause the login event. As another example, when the information system device is a laptop computer, desktop computer, or the like, a security lock based on a user account of the information system mounted on the laptop computer or desktop computer may be set, and the security lock may be released by inputting a password, biometric information, or the like set by the user. When the security lock is released in this way, the information system device may cause the login event.

When the login event occurs (S501—Yes), the information system device may proceed to step S503, and when the login event does not occur (S501—No), the information system device can wait until the login event occurs (S502).

In step S503, the information system device can confirm the reference image acquired from the camera device. Thereafter, in step S504, the information system device may extract the reference feature information including a boundary image of the face region of the user, whether or not glasses are detected, whether or not a mask is detected, or the like from the reference image, and store the reference feature information.

In step S505, the information system device may confirm whether the user access confirmation event has occurred.

Since the user access confirmation event may occur periodically at predetermined time intervals (for example, one minute) from a point in time when the user logs in, when the user access confirmation event does not occur (S505—No), the user can wait until the user access confirmation event occurs in the next cycle (S506).

Meanwhile, when the user access confirmation event occurs (S505—Yes), step S507 is performed, and in step S507, the information system device may confirm the target image acquired from the camera device. Then, in step S508, the information system device may extract the target feature information including the boundary image of the face region of the user, whether or not glasses are detected, whether or not a mask is detected, or the like from the target image.

In step S509, the information system device may compare the target feature information with the reference feature information to confirm whether the two pieces of information are the same. When the compared pieces of information, that is, the target feature information and the reference feature information are the same (S510—Yes), the use of the electronic device can be maintained without restriction.

On the other hand, when the target feature information is not the same as the reference feature information (S510—No), it is possible to block user access by blocking the output of the output device or the input of the input device (S511).

Additionally, when the user does not use the information system device 100 and is absent, the target feature information may not be confirmed, and thus, when the facial region ROI for confirming the target feature information is not extracted from the target image in step S508, the information system device 100 may generate an error message and proceed to step S511 to block the user access.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A user access control method for an information system, comprising:
processing login of a user using the information system;
acquiring a reference image obtained by capturing the logged-in user on the basis of a login time;
extracting reference feature information from the reference image and storing the reference feature information;
acquiring target images obtained by capturing a user using the information system at predetermined intervals;
extracting each target feature information from each target image;
comparing each target feature information with the reference feature information to confirm whether or not each user using the information system at predetermined intervals is the same as the logged-in user; and
controlling an access for the user using the information system when the user using the information system is not the same as the logged-in user.

2. The user access control method of claim 1, wherein extracting the reference feature information includes extracting a region of interest (ROI) which is a region in which a face of the logged-in user is preset, from the reference image, and
wherein extracting each target feature information includes extracting a region of interest which is a region in which a face of the user using the information system is present, from each target image.

3. The user access control method of claim 1, wherein extracting the reference feature information includes extracting a skin region boundary image indicating a boundary of the region in which skin of the logged-in user is present, and
wherein extracting each target feature information includes extracting a skin region boundary image indicating a boundary of the region in which skin of the user using the information system is present.

4. The user access control method of claim 1, wherein extracting the reference feature information includes extracting glasses detection information indicating whether or not glasses of the logged-in user are present, and
wherein extracting each target feature information includes extracting glasses detection information indicating whether or not glasses of the user using the information system are present.

5. The user access control method of claim 1, wherein extracting the reference feature information includes extracting mask wearing information indicating whether or not a mask of the logged-in user is present, and
wherein extracting each target feature information includes extracting mask wearing information indicating whether or not a mask of the user using the information system is present.

6. The user access control method of claim 1, wherein controlling the access for the each user using the information system includes switching to a state in which an input of an input device included in the information system is restricted or a state in which an output of an output device included in the information system is restricted.

7. The user access control method of claim 1, wherein controlling the access for the each user using the information system includes maintaining an operation of the information system without restricting the operation of the information system when each user using the information system is the same as the logged-in user.

8. The user access control method of claim 1, wherein controlling the access for the each user using the information system includes checking whether or not the user using the information system is the same as the logged-in user using a first target feature information corresponding to a first target image captured at a first time among predetermined intervals, and then, deleting the first target feature information corresponding to the first target image captured at the first time.

9. The user access control method of claim 8, wherein controlling the access for the each user using the information system includes acquiring a second target image obtained by capturing the user using the information system when a time of the predetermined intervals has elapsed from the first time.

10. The user access control method of claim 2, wherein controlling the access for each user using the information system includes controlling the access so that each user using the information system is restricted, when the region of interest which is the region in which the face of the user using the information system is present is not extracted from each target image.

11. A user access control apparatus for an information system, the apparatus comprising:
a storage medium storing one or more instructions, and
a processor configured to execute the one or more instructions to:
process login of users using an information system,
acquire a reference image obtained by capturing the logged-in user on the basis of a login time,
extract reference feature information from the reference image and store the reference feature information,
acquire target images obtained by capturing a user using the information system at predetermined intervals,
extract each target feature information from each target image,
compare the target feature information with the reference feature information to confirm whether or not each user using the information system at predetermined intervals is the same as the logged-in user, and
control an access for the user using the information system.

12. The user access control apparatus of claim 11, wherein the processor is configured to:
extract a region of interest (ROI) which is a region in which a face of the logged-in user is preset, from the reference image, and
extract a region of interest which is a region in which a face of the user using the information system is present, from the target image.

13. The user access control apparatus of claim 11, wherein the processor is configured to switch to a state in which an input of an input device included in the information system is restricted or a state in which an output of an output device included in the information system is restricted.

14. The user access control apparatus of claim 11, wherein the processor is configured to check whether or not the user using the information system is the same as the logged-in user using a first target feature information corresponding to a first target image captured at a first time among predetermined intervals, and then, delete the first target feature information corresponding to the first target image captured at the first time.

15. The user access control apparatus of claim 11, wherein the processor is configured to acquire the target image obtained by capturing the user using the information system at a second time when a time of the predetermined time intervals has elapsed from the first time.

16. The user access control apparatus of claim 12, wherein the processor is configured to control the access so that each user using information system is restricted, when the region of interest which is the region in which the face of the user using the information system is present is not extracted from the each target image.

17. A non-transitory computer readable storage medium storing computer executable instructions, wherein the instructions, when executed by a processor, cause the processor to perform a user access control method, the method comprising:
processing login of a user using the information system;
acquiring a reference image obtained by capturing the logged-in user on the basis of a login time;
extracting reference feature information from the reference image and storing the reference feature information;
acquiring target images obtained by capturing a user using the information system at predetermined intervals;
extracting each target feature information from each target image;
comparing each target feature information with the reference feature information to confirm whether or not each user using the information system at predetermined intervals is the same as the logged-in user; and
controlling an access for the user using the information system when the user using the information system is not the same as the logged-in user.

18. The non-transitory computer readable storage medium of claim 17, wherein extracting the reference feature information includes extracting a region of interest (ROI) which is a region in which a face of the logged-in user is preset, from the reference image, and
wherein extracting each target feature information includes extracting a region of interest which is a region in which a face of the user using the information system is present, from each target image.

19. The non-transitory computer readable storage medium of claim 17, wherein extracting the reference feature information includes extracting a skin region boundary image indicating a boundary of the region in which skin of the logged-in user is present, and
wherein extracting each target feature information includes extracting a skin region boundary image indicating a boundary of the region in which skin of the user using the information system is present.

20. The non-transitory computer readable storage medium of claim 18, wherein controlling the access for each user using the information system includes controlling the access so that each user using the information system is restricted, when the region of interest which is the region in which the face of the user using the information system is present is not extracted from each target image.
